(19) United States
(12) Patent Application Publication
(10) Pub. No.: US 2026/0146446 A1
(43) Pub. Date: May 28, 2026

(54) WOODEN WALL PANELS AND METHODS FOR FORMING SAME

(71) Applicant: North Woods Mass Timber, LLC, Deering, NH (US)

(72) Inventor: Emory Baldwin, Deering, NH (US)

(21) Appl. No.: 19/386,800

(22) Filed: Nov. 12, 2025

Related U.S. Application Data
(60) Provisional application No. 63/724,957, filed on Nov. 26, 2024.

(51) Int. Cl. E04C 2/24; B30B 9/28; E04B 2/00

(52) U.S. Cl. CPC E04C 2/243; B30B 9/28; E04C 2/46

(57) ABSTRACT

A method for forming a wall panel may involve arranging at least first and second spacers on a first outer wood layer, with an adhesive being disposed between the first outer wood layer and the first and second spacers, so that a gap is formed between the first and second spacers. Pressure of least fifty pounds per square inch (psi) may be applied to the first outer wood layer to cause formation of a tight bond between the first outer wood layer and the first and second spacers as the adhesive at least partially cures.

### RELATED APPLICATIONS

This application claims the benefit under 35 U.S.C. § 119(e) of U.S. Provisional Application Ser. No. 63/724,957, entitled WALL PANEL HAVING ONE OR MORE WOOD LAYERS ATTACHED TO ONE OR MORE SPACERS AND/OR AN INSULATING MATERIAL USING AN ADHESIVE AND METHOD FOR FORMING SAME, filed Nov. 26, 2024, the entire contents of which are incorporated herein by reference for all purposes.

### BACKGROUND

“Mass timber” production processes, including cross-laminated timber (CLT) and glulam, are known. In such processes, a stack of wood planks is formed, with a polyurethane resin (PUR) adhesive being applied between vertically adjacent planks, and an industrial press is used to apply high pressure, e.g., approximately 100 pounds per square inch (psi), for a cycle time of 15-45 minutes, providing sufficient curing time for the resin. With CLT, each layer includes multiple wood planks oriented side-by-side, and the planks in vertically adjacent layers are oriented perpendicular to one another, thus forming relatively thick panels that can be used as sections of walls or floors. With glulam, each layer typically includes only a single plank, and the planks in all of the layers are oriented in the same direction, thus forming elongated structures that can be used as columns or beams. Accordingly, such processes can be used to create environmentally friendly, structurally-sound, wood-based panels, beams, and columns for use in building construction.

### SUMMARY

In some aspects, the techniques described herein relate to a method for forming a wall panel including: arranging at least first and second spacers on a first outer wood layer, with an adhesive being disposed between the first outer wood layer and the first and second spacers, so that a gap is formed between the first and second spacers; and applying pressure of at least fifty pounds per square inch (psi) to the first outer wood layer to cause formation of a tight bond between the first outer wood layer and the first and second spacers as the adhesive at least partially cures.

In some aspects, the techniques described herein relate to a wall panel including: a first outer wood layer including a first plurality of wood boards arranged edge to-edge; a second outer wood layer including a second plurality of wood boards arranged edge-to-edge; at least first and second wood spacers disposed between the first outer wood layer and the second outer wood layer so that a gap is formed between the first spacer and the second spacer, wherein the first and second spacers are attached to each of the first and second outer wood layers using an adhesive.

### BRIEF DESCRIPTION OF THE DRAWINGS

FIG. 1 shows a perspective view of an example wall panel configured in accordance with some implementations of the present disclosure.

FIG. 2 is a sectional view of a wall panel of the type shown in FIG. 1 in accordance with some implementations of the present disclosure.

FIG. 3 is a sectional view illustrating how a wall panel of the type shown in FIGS. 1 and 2 may be installed in a building structure, in accordance with some implementations of the present disclosure.

FIG. 4 shows an example industrial press that may be used to apply pressure during manufacturing of a wall panel, in accordance with some implementations of the present disclosure.

### DETAILED DESCRIPTION

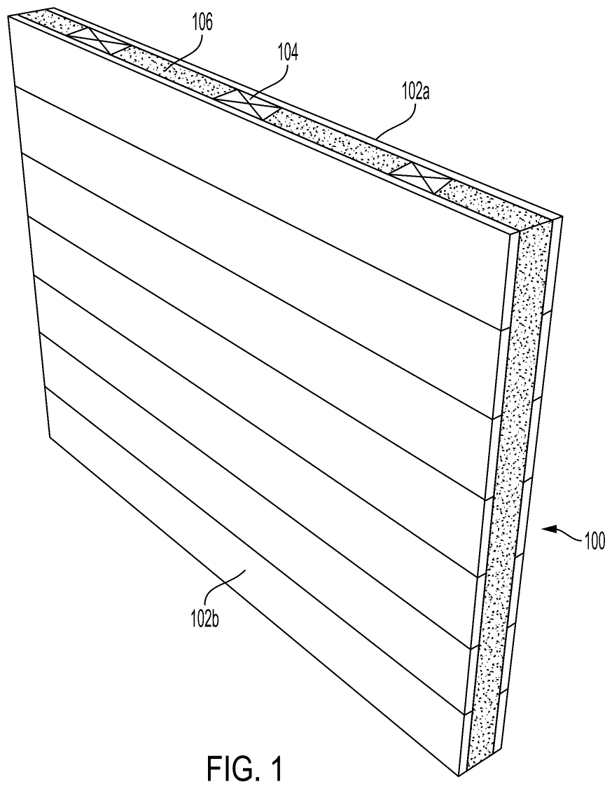

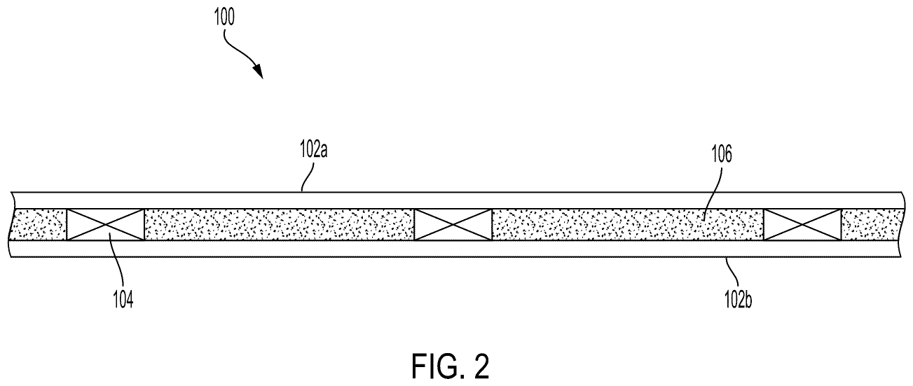

The present application is directed to prefabricated wall panels having one or more outer layers made of solid wood material (e.g., edge-glued boards) attached to spacers (e.g., wood studs) using an adhesive, thus forming a structure that similar to a CLT panel but includes regions (between the spacers) that are not composed of solid wood. In some implementations, such regions may instead be filled with an insulating material (e.g., a wood fiber insulation). In some implementations, an industrial press of the type used to create CLT panels may be used to apply high pressure to the outer layer(s) as the adhesive at least partially cures to create a tight bond between the outer layer(s) and the spacers. The resulting structures may thus have an external appearance and structural integrity similar to CLT panels, but may be lighter weight and less expensive to manufacture, as they require a reduced amount of solid wood material. The pre-fabricated wall panels disclosed herein may be particularly well suited for use as internal walls of a building. An example wall panel 100 configured in accordance with the present disclosure is shown in FIGS. 1-3.

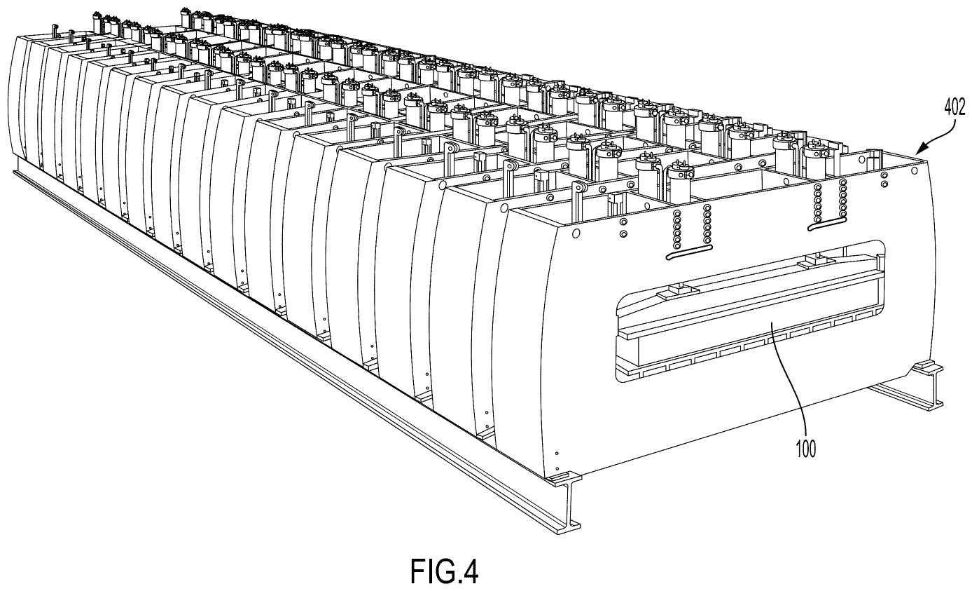

Referring to FIGS. 1-3, to fabricate a wall panel 100 in accordance with some embodiments of the present disclosure, one or more outer layers 102a, 102b made of a solid wood material (e.g., edge-glued boards or boards that simply arranged edge-to-edge) may be assembled, similar to assembly of individual layers of a CLT lay-up. However, instead of vertically stacking several such solid wood layers directly on top of one another (as with a CLT layup), spacers 104 (e.g., 2×3, 2×4 or 2×6 wood studs), and possibly insulation 106, may be layered in, thus creating a ‘sandwich’ wall system: e.g., single edge-glued layer—insulation/stud middle core—single edge-glued layer. Adhesive (e.g., a PUR adhesive) may be applied between the outer wood layers 102 and spacers 104, and the sandwich may be placed in an industrial press 402, e.g., as shown in FIG. 4. Similar to a CLT process, the industrial press 402 may apply a high pressure (e.g., greater than 50 psi, or greater than 60 psi, or greater than 70 psi, or greater than 80 psi, or greater than 90 psi, or greater than 100 psi) to the outer wood layers of the sandwich as the adhesive at least partially cures (e.g., for 15-45 minutes), thus creating a very tight bond between the outer wood layers 102 and the spacers 104.

The outer wood layers 102a, 102b may be made, for example, with finger-jointed boards. In some implementations, the wall panels 100 may measure, for example, eight feet to ten feet in height and up to sixty feet in length, although many other size configurations are possible and may be customized to accommodate demand.

In some implementations, the wood panel 100 may include a first outer wood layer 102a and a layer of adhesive, e.g., a non-toxic PUR glue, may be applied to a top surface of the first outer wood layer 102a. A layer of insulation 106 (e.g., wood fiber insulation) may be coupled to the first outer wood layer 102a using the adhesive. The insulation 106 may be any suitable thickness including, but not limited to 1 inch, 1.5 inches, 2 inches, 2.5 inches, 3 inches, 3.5 inches, 4 inches, 4.5 inches, 5 inches, or 5.5 inches, and may vary depending on the width and/or depth of the spacers 104. In some implementations, the thickness of the insulation 106 may be substantially the same as the width and/or depth of the spacers 104, so that the insulation fills the entire void between the first outer wood layer 102a and a second outer wood layer 102b. The insulation 106 may come in any suitable width including, but not limited, to 14.5 inch wide strips, e.g., to fill the entirety of the void between 1.5 inch wide studs placed at 16 inches on center. It should thus be appreciated that, in contrast to CLT walls which are formed entirely of wood, the wall panels 100 configured in accordance with the present disclosure may have a hollow or insulated core, the advantages of which are described in more detail below.

In some implementations, the spacers 104 (e.g., wood studs) may be coupled to the first outer wood layer 102a using the adhesive and may alternate with the insulation 106. The spacers 104 may be any suitable size including, but not limited, to 2×3, 2×4 or 2×6 studs. The spacers 104 may be oriented in various directions, for example, perpendicular to the edge-glued boards of the outer wood layers 102a, 102b, so that each spacer 104 may come into contact with each edge-glued board of the outer wood layers 102a, 102b. Once the spacers 104 and/or the insulation 106 are coupled to the first outer wood layer 102a, a second layer of the adhesive may be applied to the opposite faces of the spacers 104 and/or the insulation 106. It should be appreciated that the spacers 104 may be configured and arranged to provide for minimized wall thickness with increased strength and rigidity, as described in more detail below.

In some implementations, the second outer wood layer 102b may be coupled to the faces of the spacers 104 and/or the insulation 106, opposite the first outer wood layer 102a. This three-layer “sandwich” may then be rolled into an industrial press 402 (e.g., as shown in FIG. 4) which may apply pressure evenly across the first outer wood layer 102a and/or the second outer wood layer 102b. Pressure from an industrial press 402 may be, for example, approximately 100 pounds per square inch (psi). In some implementations, the press 402 may be able to accommodate wall panels 100 that are up to sixty feet in length and twelve feet in width. The press 402 may also be able to accommodate multiple wall panels 100 stacked on top of one another in a single press cycle. The press time may last approximately 15 to 45 minutes to allow the adhesive to cure at least partially under high pressure, and then the finished wall panels 100 may come out the other end of the press 402 and be stored in another stacking tray while the adhesive fully cures. In some implementations, for example, the finished wall panels 100 may be allowed to cure for an additional two to twenty four hours after they leave the press 402, to ensure they are fully cured before they are further processed and/or distributed to a job site.

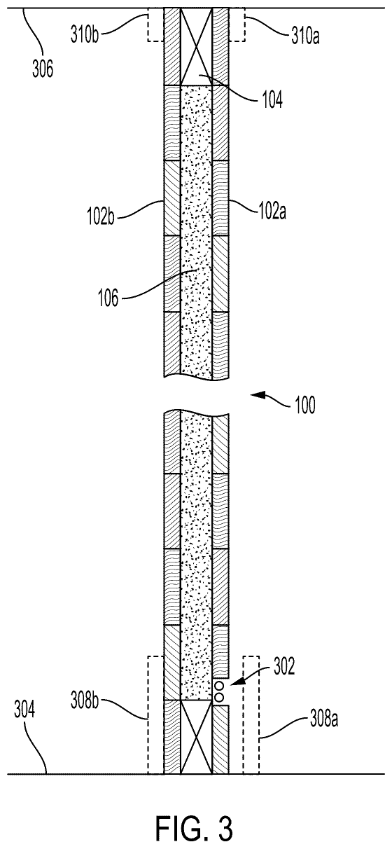

In some implementations, after the adhesive of the wall panels 100 is fully cured, the wall panels 100 may be further processed. For example, the wall panels may be run through a large format sanding machine and/or a computer numerical control (CNC) machine that may cut out openings for doors and/or electrical boxes (e.g., for switches, outlets, etc.). The wall panels 100 may be customized for each project, as described below. For example, the CNC machine may also cut a channel or groove 302 (see FIG. 3) into at least one of the outer wood layers 102a, 102b of the wall panel 100, e.g., near the base of the wall panel 100, so that electrical wires may be run on site once the wall panel 100 is secured in place.

In some implementations, after being produced, the wall panel 100 may be delivered by any suitable means including, but not limited, to a truck or any other suitable vehicle to a construction site and lowered into place (e.g., by a small crane) to a desired location. The wall panels 100 may then be attached in any of numerous ways, such as with screws on each end and along the top and bottom, by toe nailing, etc. As shown in FIG. 3, for example, when installed in a building structure, the wall panel 100 may be installed between a floor 304 and a ceiling 306. In some implementations, once the wall panel 100 is installed, a first base trim 308a and a first ceiling trim 310a may be coupled to the first outer wood layer 102a adjacent the floor 304 and the ceiling 306, respectively. In some implementations, a second base trim 308b and a second ceiling trim 310b may similarly be coupled to the second outer wood layer 102b adjacent the floor 304 and the ceiling 306, respectively. In some implementations, the base trim 308 and the ceiling trim 310 may be any suitable material including, but not limited to, wood, metal, plastic, or any combination thereof.

It should be appreciated that the installation time on site may be well under fifteen minutes per wall panel 100, which may be faster than a site-built wall when considering all or some of the labor-intensive, time-consuming steps that may be involved with a conventional interior partition wall that may have gypsum board on it. This may shave several weeks (if not months) of time off a large multifamily construction project. It also may save developers money (and lowers their financial risk) by reducing the amount of time for construction loans.

Examples of advantages afforded by the wall panels 100 and the process used to manufacture the same, as compared to conventional CLT, will now be described.

Instead of having solid wood for the inner layer (or layers) as a typical CLT has, the wall panels 100 may have a hollow or insulated core, thus reducing the amount of wood fiber. In the case of the insulated core option, any type and/or form of insulation (e.g., fiberglass, mineral wool, or wood fiber insulation in rigid, batt or loose form) could be used. For at least some applications, however, wood fiber insulation (in rigid, batt, or loose form) may be preferable due to its better environmental qualities. The insulation (or voids, in the case of hollow core panels) may be alternated with thin spacers 104 (e.g., wood studs) that run perpendicularly to the edge-glued boards of outer wood layers 102a, 102b (and may be spaced 16 inches on center, 24 inches on center, or some other distance apart from each other). The spacers 104 may be sprayed with adhesive and adhered to the outer wood layers 102a, 102b (e.g., via the industrial CLT press 402 shown in FIG. 4), e.g., in the same manner that the inner layers of wood are adhered to the outer layers in a typical CLT panel. In some implementations, the spacers 104 may be laid flat in order to minimize the wall thickness (and maximize space savings). Such a flat orientation may also provide more surface area for the adhesive, which may in turn increase the strength and rigidity of the wall panel 100.

After the pressed layup has cured, a CNC machine may be used to create one or more grooves 302, e.g., at the base of the wall panel 100, for running wiring and/or may cut out openings (e.g., for switches, outlets, interior doors, windows, etc.). Each wall panel 100 may be easily customized for its specific location in the intended building, thus furthering its time savings onsite.

CLT panels (and mass timber in general) support the trend towards prefabricated construction (which addresses the fact that the construction labor force is dwindling) and biophilic design (which has been proven to promote better health through exposure to natural materials). Yet, mass timber typically pertains only to large construction projects. The wall panels 100 described herein may extend the benefits and philosophy of prefabrication and mass timber to a broader range of buildings. In particular, the use of the disclosed wall panels 100 may broaden the scope of mass timber to include interior partition walls which so far have not been appropriate for CLT panels due to the intensive amount of wood used in CLTs. The wall panels 100 described herein may be far more resource efficient than standard CLTs because they may use thinner layers around a hollow or insulated core.

Whereas traditional interior sheet-rocked partition walls require a significant amount of time to assemble on site (due to all of the various trades that are needed to build them), the wall panels 100 disclosed herein may be assembled in a factory and then lifted into place and installed quickly (thus saving a tremendous amount of time on site). This means further savings (time and money) for the developer/contractor, and arguably creates a more attractive interior.

The advancements of the mass timber industry have made the creation of an efficient, high quality prefabricated interior wall system possible. The use of the wall panels 100 disclosed herein, in turn, completes and broadens the scope of mass timber and brings the benefits of mass timber to a new level.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the art should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein. Further, unless expressly stated to the contrary, features/operations/components, etc., from one embodiment discussed herein may be combined with features/operations/components, etc., from another embodiment discussed herein.

The following clauses describe example implementations of some of the novel aspects disclosed herein.

Clause 1. A method for forming a wall panel, comprising: arranging at least first and second spacers on a first outer wood layer, with an adhesive being disposed between the first outer wood layer and the first and second spacers, so that a gap is formed between the first and second spacers; and applying pressure of at least fifty pounds per square inch (psi) to the first outer wood layer to cause formation of a tight bond between the first outer wood layer and the first and second spacers as the adhesive at least partially cures.

Clause 2. The method of clause 1, wherein: the first spacer has a first surface and second surface opposite the first surface; the second spacer has a third surface and fourth surface opposite the third surface; arranging the first and second spacers on the first outer wood layer includes applying the adhesive between the first and third surfaces and the first outer wood layer; and the method further comprises, prior to applying the pressure to the first outer wood layer, applying the adhesive between the second and fourth surfaces and a second outer wood layer, so that application of the pressure also causes formation of a tight bond between the second outer wood layer and the first and second spacers as the adhesive at least partially cures.

Clause 3. The method of clause 1 or clause 2, further comprising disposing an insulating material in gap.

Clause 4. The method of clause 3, wherein the insulating material comprises wood fiber insulation.

Clause 5. The method of any of clauses 1-4, further comprising: arranging a plurality of wood boards edge-to-edge to form the first outer wood layer.

Clause 6. The method of clause 5, further comprising: edge gluing the plurality of wood boards to form the first outer wood layer.

Clause 7. The method of clause 5 or clause 6, further comprising: orienting the first and second spacers perpendicular to the plurality of boards.

Clause 8. The method of any of clauses 1-7, wherein: applying the pressure includes using a press to apply the pressure.

Clause 9. The method clause 8, wherein the press applies at least seventy five pounds per square inch of pressure to the first wood panel.

Clause 10. The method of any of clauses 1-9, wherein the first and second spacers are wood studs.

Clause 11. The method of any of clauses 1-10, wherein the adhesive is a polyurethane resin.

Clause 12. The method of any of clauses 1-11, wherein applying the pressure includes applying the pressure for at least fifteen minutes.

Clause 13. A wall panel, comprising: a first outer wood layer including a first plurality of wood boards arranged edge to-edge; a second outer wood layer including a second plurality of wood boards arranged edge-to-edge; at least first and second wood spacers disposed between the first outer wood layer and the second outer wood layer so that a gap is formed between the first spacer and the second spacer, wherein the first and second spacers are attached to each of the first and second outer wood layers using an adhesive.

Clause 14. The wall panel of clause 13, wherein: the first plurality of boards are glued edge-to-edge; and the second plurality of boards are glued edge-to-edge.

Clause 15. The wall panel of clause 13 or clause 14, wherein the first and second spacers are each oriented perpendicular to the first plurality of boards and the second plurality of boards.

Clause 16. The wall panel of any of clauses 13-15, further comprising: an insulating material disposed in the gap.

Clause 17. The wall panel of clause 16, wherein the insulating material comprises wood fiber insulation.

Clause 18. The wall panel of any of clauses 13-17, wherein the first and second wood spacers are wood studs.

Clause 19. The wall panel of any of clauses 13-18, wherein the adhesive is a polyurethane resin.

As used herein and in the appended claims, unless otherwise clear in context, the terms “comprising,” “having,” “containing,” “including,” “encompassing,” “in response to,” “based on,” and the like are intended to be open-ended in that an element or elements following such a term is not meant to be an exhaustive listing of elements or meant to be limited to only the listed element or elements.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment. Accordingly, unless otherwise clear in context, phrases such as “a device configured to” are intended to include one or more recited devices. Such one or more recited devices, unless otherwise clear in context, are collectively configured to carry out the stated recitations.

As used herein, unless otherwise clear in context, the term “or” is open-ended and encompasses all possible combinations, except where infeasible. For example, if it is stated that a component includes A or B, then, unless infeasible or otherwise clear in context, the component includes at least A, or at least B, or at least A and B. As a second example, if it is stated that a component includes A, B, or C then, unless infeasible or otherwise clear in context, the component includes at least A, or at least B, or at least C, or at least A and B, or at least A and C, or at least B and C, or at least A and B and C.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

What is claimed is:

1. A method for forming a wall panel, comprising:
arranging at least first and second spacers on a first outer wood layer, with an adhesive being disposed between the first outer wood layer and the first and second spacers, so that a gap is formed between the first and second spacers; and
applying pressure of at least fifty pounds per square inch (psi) to the first outer wood layer to cause formation of a tight bond between the first outer wood layer and the first and second spacers as the adhesive at least partially cures.

2. The method of claim 1, wherein:
the first spacer has a first surface and second surface opposite the first surface;
the second spacer has a third surface and fourth surface opposite the third surface;
arranging the first and second spacers on the first outer wood layer includes applying the adhesive between the first and third surfaces and the first outer wood layer; and
the method further comprises, prior to applying the pressure to the first outer wood layer, applying the adhesive between the second and fourth surfaces and a second outer wood layer, so that application of the pressure also causes formation of a tight bond between the second outer wood layer and the first and second spacers as the adhesive at least partially cures.

3. The method of claim 2, further comprising disposing an insulating material in gap.

4. The method of claim 3, wherein the insulating material comprises wood fiber insulation.

5. The method of claim 1, further comprising:
arranging a plurality of wood boards edge-to-edge to form the first outer wood layer.

6. The method of claim 5, further comprising:
edge gluing the plurality of wood boards to form the first outer wood layer.

7. The method of claim 5, further comprising:
orienting the first and second spacers perpendicular to the plurality of boards.

8. The method of claim 1, wherein:
applying the pressure includes using a press to apply the pressure.

9. The method claim 8, wherein the press applies at least seventy five pounds per square inch of pressure to the first wood panel.

10. The method of claim 1, wherein the first and second spacers are wood studs.

11. The method of claim 1, wherein the adhesive is a polyurethane resin.

12. The method of claim 1, wherein applying the pressure includes applying the pressure for at least fifteen minutes.

13. A wall panel, comprising:
a first outer wood layer including a first plurality of wood boards arranged edge to-edge;
a second outer wood layer including a second plurality of wood boards arranged edge-to-edge;
at least first and second wood spacers disposed between the first outer wood layer and the second outer wood layer so that a gap is formed between the first spacer and the second spacer, wherein the first and second spacers are attached to each of the first and second outer wood layers using an adhesive.

14. The wall panel of claim 13, wherein:
the first plurality of boards are glued edge-to-edge; and
the second plurality of boards are glued edge-to-edge.

15. The wall panel of claim 13, wherein the first and second spacers are each oriented perpendicular to the first plurality of boards and the second plurality of boards.

16. The wall panel of claim 13, further comprising:
an insulating material disposed in the gap.

17. The wall panel of claim 16, wherein the insulating material comprises wood fiber insulation.

18. The wall panel of claim 13, wherein the first and second wood spacers are wood studs.

19. The wall panel of claim 13, wherein the adhesive is a polyurethane resin.
